(19) United States
(12) Patent Application Publication
(10) Pub. No.: US 2018/0239864 A1
(43) Pub. Date: Aug. 23, 2018

(54) HARDWARE ACCELERATOR FOR ALIGNMENT OF SHORT READS IN SEQUENCING PLATFORMS

(71) Applicant: INDIAN INSTITUTE OF SCIENCE, Bangalore, Kamataka (IN)

(72) Inventors: Santhi NATARAJAN, Bangalore (IN); Debnath PAL, Bangalore (IN); S. K. NANDY, Bangalore (IN)

(21) Appl. No.: 15/554,592

(22) PCT Filed: Feb. 17, 2016
(86) PCT No.: PCT/IB2016/050839

§ 371 Date: Aug. 30, 2017

(30) Foreign Application Priority Data
Mar. 5, 2015 (IN) 1088/CHE/2015

(51) Int. Cl. G06F 19/22; G06F 19/28

(52) U.S. Cl. CPC G06F 19/22; G06F 19/28

(57) ABSTRACT

The present disclosure relates to an aligner in a hardware accelerator that can align short reads with a reference genome as genomic data is streamed through the hardware accelerator and thus can speed up the process of alignment. In an aspect, the disclosed short read aligner can incorporate a number of hardware kernels modelled as processor array implementation of the cost function model of the dynamic programming algorithm having a number of processing elements, wherein each kernel can incorporate a traceback control block as a separate hardware that enables traceback in parallel to the processor array and alignment matrix filling process by use of trace back direction vectors and using additional trackback path prediction features. The disclosed aligner can be parameterized and can perform alignment for cost function models of different variations of chosen dynamic programming algorithm. The aligner incorporates adequate sequence partitioning, scheduling, alignment and stitching schemes to accommodate short reads of variable lengths for alignment.

### TECHNICAL FIELD

The present disclosure generally relates to the field of bioinformatics and molecular biology. In particular, the present disclosure pertains to a scalable hardware accelerator to map and align genomic data.

### BACKGROUND

Background description includes information that may be useful in understanding the present invention. It is not an admission that any of the information provided herein is prior art or relevant to the presently claimed invention, or that any publication specifically or implicitly referenced is prior art.

Latest technical advances in sequencing have revolutionized many aspects of biology and medicine. These advances have dramatically lowered the cost and exponentially increased the throughput of DNA sequencing. As a result sequencing technology is now being applied to a rapidly widening array of scientific and medical problems, from basic biology to forensics, ecology, evolutionary studies, agriculture, drug discovery, and the growing field of personalized medicine.

Sequencing machines determine the nucleotide sequence of short DNA fragments, typically a few tens to hundreds of bases, called short reads. With present day sequencing technologies this can be done in a massively parallel manner, yielding much higher throughput than older sequencing technologies—on the order of tens of billions of bases per day from one machine. For comparison, the human genome is approximately 3 billion bases in length.

For most applications, a complete genetic sequence of an organism is not determined de novo. Rather, in most instances, for the organism in question, a “reference” genome sequence has already been determined and is known. Since the short reads are derived from randomly fragmenting genome of one organism for which a reference genome sequence is already known, the first step for data analysis is ordering of all of these fragments to determine the overall gene sequence of the individual sample using the reference genome sequence effectively as a template, i.e., mapping these short read fragments to the reference genome sequence. In this analysis, a determination is made concerning the best location in the reference genome to which each short read maps, and is referred to as the short read mapping problem.

Short read mapping problem is technically challenging, both due to the volume of data and because sample sequences may not be identical to the reference genome sequence, but as expected, will contain a wide variety of individual genetic variations. Due to the sheer volume of data, e.g., a billion short reads from a single sample, the speed or runtime of the data analysis is significant, with the data analysis now becoming the effective bottleneck in genomic sequencing. In addition, successful sequencing should exhibit sensitivity to genetic variations to successfully map sequences that are not completely identical to the reference, both because of technical errors in the sequencing and because of genetic differences between the subject and the reference genome.

Biologists and other researchers use sequence alignment as a fundamental comparison method to find common patterns between sequences, predict protein structure, identify important genetic regions, and facilitate drug design. For example, sequence alignment is used to derive flu vaccines by identifying DNA signatures of pathogens. Since biological sequence alignment is now an essential tool used in molecular biology and biomedical applications, it is essential that alignment results are available in a timely manner. The growing volume of genomic data and the complexity of sequence alignment present a challenge in obtaining accurate alignment results in a timely manner.

A number of softwares are available in art that perform short read alignment with the reference genome for example BWA, Novoalign, Bowtie, SOAP2, BFAST, SSAHA2, Mpscan, GASSST, Churchill etc. These software based approaches have number of limitations such as use of heuristic algorithms for mapping that reduces the accuracy as compared to exact algorithms. In addition, they take more time to perform alignment of millions of short reads, making short read mapping the major task affecting the throughput and performance of the sequencing pipeline.

Very few attempts have been made to develop short read mapping accelerators in hardware. One such model for short read mapping has been developed based on research sponsored by Washington Technology Center (WTC) and Pico Computing. This platform performs mapping of 50 million 76 bp short reads from one of the paired end Illumina GA IIx run on human exome data. The hardware is based on a 24-FPGA Pico Computing system. The platform uses BFAST algorithm for indexing, and Smith Waterman and Needleman Wunsch Algorithms for scoring. However this platform is not scalable and time taken for alignment is decided by problem size. Furthermore, the accuracy is compromised due to heuristics involved.

Smith Waterman algorithm is a dynamic programming method for determining similarity between a pair of nucleotide or protein sequences. It ensures the best optimal alignment between sequences. The algorithm is used for performing pairwise local alignment of DNA or protein sequences. A pairwise alignment finds highly related subsequences of two sequences. It identifies subsequences that are preserved during the course of evolution. It is highly useful for dissimilar sequences suspected to contain regions of similarity within their larger sequence context. The alignment need not include entire length of the two sequences. The method is very sensitive in detecting similarity between two sequences sharing evolutionary origin along the entire length, while part of the sequence under strong enough selection pressure to preserve valid similarity.

There have been several attempts to accelerate the Smith Waterman Dynamic programming algorithm in hardware. However, these implementations suffer from various short comings such as sequence length considered for alignment is limited by the hardware size, the architectures are not inherently scalable, they do not perform traceback with forward scan in overlapped mode, their performance is limited by hardware I/O bandwidth, they have severe processing overhead in software when alignment matrix is recalculated. Besides they also have severe memory bottleneck issues.

There is therefore a need for a solution that overcomes the drawbacks of the known methods and provides a hardware accelerator for accurate mapping and alignment of short reads in high throughput Sequencing Platforms.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### OBJECTS OF THE INVENTION

An object of the present disclosure is to overcome the drawbacks of existing methods of short read mapping and alignment with a reference genome sequence.

Another object of the present disclosure is to provide a hardware accelerator that overcomes the drawbacks of existing methods of short read mapping and alignment with a reference genome sequence.

Another object of the present disclosure is to use a dynamic programming algorithm such as Smith Waterman algorithm for pairwise sequence alignment of a short read with a reference genome sequence to achieve accurate results.

Another object of the present disclosure is to provide an accelerator architecture that supports streaming of genomic data from host, thereby drastically reducing storage requirements within the accelerator platform while indexing, mapping and alignment and speeds up the mapping and alignment of short reads with a reference genome sequence.

Another object of the present disclosure is to provide an aligner architecture that enables traceback parallel to alignment matrix filling process thus saving alignment time.

### SUMMARY

Aspects of present disclosure relate to alignment of short reads with a reference genome sequence (interchangeably referred to as reference genome, reference sequence or reference fragment hereinafter). In an aspect, the disclosure provides a hardware accelerator that can speed up the process of alignment of short reads (also referred to simply as read hereinafter) with the reference genome in high throughput sequencing platforms.

In an aspect, the disclosed hardware architecture does not depend on heuristic algorithms and performs exact mapping and exact alignment, resulting in no error. In another aspect, the proposed architecture uses a cost function model of the dynamic programming algorithm for pairwise sequence alignment for determining similarity between a pair of nucleotide or protein sequences, and ensures best optimal alignment between the sequences.

In another aspect of the disclosure, the hardware accelerator can consist of multiple data paths for mapping and alignment which can run in parallel on the scheduled data. Each datapath can consist of a Short Read to Reference Mapper (interchangeably referred to simply as mapper) and Short Read Aligner (also referred to simply as aligner).

In an aspect, the hardware accelerator can function with independent, decoupled mapper and aligner models as well, where the mapper alone is present in the pipeline initially, which can perform mapping and filtering of read-RIT pairs, which are probable candidates for alignment. Thereafter, the filtered read-RIT pairs can be streamed to the accelerator again, which has only aligner present in the datapath, which can perform alignment on the incoming pairs, and produce the scores and associated results for each pair for streaming as output data.

In another aspect of the present disclosure, each Short Read Aligner can have an array of processors, which in its various embodiments can function as a parallel pipeline of hardware kernels. These processors (referred to as processing elements hereinafter) can be scheduled on any coarse grain reconfigurable architecture. In an aspect the disclosed hardware architecture is a high availability solution that exploits re-configurability of the target platform on which it is realized. As would be apparent to a person skilled in art, the disclosed coarse grain reconfigurable architecture that hosts the parallel pipeline of hardware kernels can provide the necessary and sufficient features to make the design fault tolerant.

In implementation each processing element in the kernel can hold one element (referred to as query element) of the reference genome (referred to as query sequence) and elements (referred to as subject elements) of the short read (referred to as subject sequence) can be shifted through the processor array. In an aspect, number of PEs is scalable and can be tailored to meet the input sequence size and the target platform requirements.

In an embodiment each of the processing elements in the array can host cost function of a dynamic programming algorithm for pairwise sequence alignment. In an aspect the cost function may not be limited to integer/floating point/fixed point etc and thus provide a choice of datatype. The dynamic programming algorithm can be highly parameterized to encompass all variations of the algorithm for pairwise alignment. In an embodiment of implementation, the dynamic programming algorithm used can be Smith-Waterman dynamic programming algorithm and can implement affine gap penalty model and substitution matrix for computing costs. In yet another aspect of the disclosure, hardware kernel can incorporate an alignment matrix fill block that can populate a two dimensional alignment matrix with score or distance values during forward scan and can perform score calculation. The hardware kernel can further incorporate a traceback control block configured to implement traceback in parallel to the processor array and alignment matrix filling process.

In yet another aspect, the kernel can provide a final optimal alignment output in the form of a sequence pair, wherein elements in the final alignment can be extracted from traceback path vectors calculated by a traceback control logic. The kernel can also provide any or a combination of maximum score, start positions, and end positions of alignment as output.

In another aspect, the aligner can be parameterized and can perform alignment for various the cost function models of the dynamic programming algorithm. The aligner can have adequate sequence partitioning, scheduling, alignment and stitching schemes to accommodate short reads of variable lengths for alignment.

Various objects, features, aspects and advantages of the inventive subject matter will become more apparent from the following detailed description of preferred embodiments, along with the accompanying drawing figures in which like numerals represent like components

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 illustrates an exemplary block diagram of general computational infrastructure for data transport from sequencing platforms for storage and analysis including hardware accelerators for genomic data alignment in the data path in accordance with embodiments of the present disclosure.

FIG. 2 illustrates an exemplary block diagram of hardware accelerator architecture with the streaming interface in accordance with embodiments of the present disclosure.

FIG. 3 illustrates an exemplary block diagram indicating multiple datapaths for mapper and aligner within the hardware accelerator architecture in accordance with embodiments of the present disclosure.

FIG. 4 illustrates an exemplary block diagram indicating architecture of an aligner in accordance with embodiments of the present disclosure.

FIG. 5 illustrates an exemplary block diagram indicating architecture of an alignment kernel in accordance with embodiments of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims.

Various terms as used herein are shown below. To the extent a term used in a claim is not defined below, it should be given the broadest definition persons in the pertinent art have given that term as reflected in printed publications and issued patents at the time of filing.

Embodiments of present disclosure relate to alignment of short reads with a reference genome. In an aspect, the disclosure provides a hardware accelerator that can speed up the process of alignment of short reads (also referred to simply as read hereinafter) with the reference genome in high throughput sequencing platforms.

In an embodiment, the disclosed hardware architecture does not depend on Heuristic algorithms and performs exact mapping and exact alignment, resulting in no error. In another aspect, the proposed architecture uses a cost function model of the dynamic programming algorithm for pairwise sequence alignment for determining similarity between a pair of nucleotide or protein sequences, and ensures best optimal alignment between the sequences.

In another embodiment of the disclosure, the hardware accelerator can include multiple data paths for mapping and alignment, which can run in parallel on scheduled data, wherein each data path can include a Short Read to Reference Mapper (interchangeably referred to simply as mapper) and a Short Read Aligner (also referred to simply as aligner). In another aspect, the aligner can be parameterized and can perform alignment for various cost function models of the dynamic programming algorithm. The aligner can have adequate sequence partitioning, scheduling, alignment and stitching schemes to accommodate short reads of variable lengths for alignment.

In an alternate embodiment, the hardware accelerator can function with independent, decoupled mapper and aligner models as well, where the mapper alone is present in the pipeline initially, which can perform mapping and filtering of read-RIT (Reference Index Table) pairs, which are probable candidates for alignment. Thereafter, the filtered read-RIT pairs can be streamed to the accelerator again, which has only aligner present in the datapath, which can perform alignment on the incoming pairs, and produce the scores and associated results for each pair for streaming as output data.

In another aspect of the present disclosure, each Short Read Aligner can have an array of processors, which in its various embodiments can function as a parallel pipeline of hardware kernels. These processors (referred to as processing elements hereinafter) can be scheduled on any coarse grain reconfigurable architecture. In an aspect the disclosed hardware architecture is a high availability solution that exploits re-configurability of the target platform on which it is realized. As would be apparent to a person skilled in art, the disclosed coarse grain reconfigurable architecture that hosts the parallel pipeline of hardware kernels can provide the necessary and sufficient features to make the design fault tolerant.

In implementation each processing element in the kernel can hold one element (referred to as query element) of the reference genome (referred to as query sequence) and elements (referred to as subject elements) of the short read (referred to as subject sequence) can be shifted through the processor array. In an aspect, number of PEs is scalable and can be tailored to meet the input sequence size and the target platform requirements.

In an embodiment, each of the hardware kernels can incorporate an alignment matrix fill block that can populate a two dimensional alignment matrix with score or distance values during forward scan and can do score calculation. The hardware kernel can further incorporate a traceback control block configured to implement traceback in parallel to the processor array and alignment matrix filling process.

In an embodiment each of the processing elements in the array can host cost function of a dynamic programming algorithm for pairwise sequence alignment. In an aspect the cost function may not be limited to integer/floating point/fixed point etc and thus can provide a choice of datatype. The dynamic programming algorithm can be highly parameterized to encompass all variations of the algorithm for pairwise alignment. In an embodiment of implementation, the dynamic programming algorithm used can be Smith-Waterman dynamic programming algorithm and can implement affine gap penalty model and substitution matrix for computing costs for local pairwise sequence alignment. The substitution matrix look up table within the processing element can be implemented for chosen standard substitution matrix such as DNAfull. In an embodiment, in order to accommodate a new substitution matrix, the look up table just needs to be changed for the values.

In another embodiment, penalty attributed to a gap and extension of a gap can also be stored in the PE, wherein the PE can keep a track of the maximum value generated in the matrix so far. The maximum value can thus be propagated from start to end of the processor array. The last PE in the array can provide maximum value as the highest score output from the kernel.

In another embodiment, the PE can also save the direction of cell update based on location of parent cell from which current update value was calculated. A cell update can happen from the cell on top or from the cell to its left or from the top left diagonal cell. This can be shared with traceback control logic in the kernel in the form of a traceback direction vector, which can serve as an input to direction calculation and path prediction during traceback process.

In another embodiment, for every clock, the PE can check whether current pairing due to alignment is match or mismatch, wherein if a match is found, PE can calculate the score based on score or substitution matrix, else, if a mismatch is found, the PE can calculate the penalty for a gap based on affine gap model and based on gap/gap extension penalty values.

In an embodiment, whenever a match is found in the input element pair, the corresponding diagonal match value and diagonal indel value can be calculated in parallel. The values can be compared to find the maximum between the two, wherein the resultant maximum value can then be added to the match score value obtained based on the substitution matrix look up table, which value can then be processed to provide final match value to be communicated to the next PE.

In another embodiment, whenever a mismatch occurs in the input sequence element pair, the indel value can be calculated based on the gap open penalty and gap extension penalty values. The maximum of the gap open penalty from the left and gap extension penalty from the left is calculated and can be compared against the maximum of gap open penalty and gap extension penalty from the top cell such that the maximum of left penalty and top penalty can be found to finally obtain the indel value to be transferred to the next PE.

In an embodiment, the processing element can complete its job by traversing through four internal stages of the control state machine, namely init, alignment, scoring, and traceback. The PE can be initialized for its look up table, gap open penalty, gap extension penalty values, and for other system parameters during the init state, post which the PE can then wait for the valid command indicating the start of alignment and the PE can be triggered for an alignment by an active high on the valid signal, following which the PE can receive input sequence elements.

In an embodiment, the PE can proceed to the scoring state where the alignment matrix can be filled based on the cost function model of the dynamic programming algorithm. The traceback can happen in parallel with alignment in this stage. This state machine can be active in all the PEs within the kernel in parallel during the alignment matrix fill process and traceback. At the end of matrix fill contributed by all the PEs, optimal alignment and maximum score can be provided as output of the kernel. The PEs can then get back to the init state waiting for the next set of inputs.

In an embodiment, each PE can perform one elementary calculation per clock based on the cost function model of the dynamic programming algorithm. Each PE can be responsible for populating one column of the alignment matrix. The PE can generate one alignment matrix element per clock, wherein calculation of current PE can depend on results of the previous PE or parent. Thus, each PE can be one cycle behind the predecessor in the processor chain, enabling each kernel to generate one complete alignment matrix for one sequence pair alignment.

In an embodiment, the maximum value calculated during each cell update can be propagated across the processor array. PE in the array can calculate the current cell update value, and compare it with the input maximum value such that if the current value is greater than the maximum value hit so far, the maximum value can be replaced by the current update value and propagated to the next PE. The last PE in the processor array can thus provide the highest score in the alignment matrix as output.

In an embodiment, while the alignment matrix is being populated, a traceback can be triggered for the current maximum value after evaluating whether it is eligible for a traceback. The eligibility for traceback can be calculated based on the direction vectors populated by each PE for each matrix cell update. The direction vectors can be calculated based on the parameters such as current score value, the parent cell from which the current value was calculated, the relative position of the current PE from the parent PE, current maximum value, the parent cell from which reported the current maximum value, the relative position of the current PE from the maximum value PE.

In an embodiment, if there is a valid path defined by the direction vectors of the parents preceding the current maximum value PE, a traceback can be triggered. The traceback can enable signal and the traceback ID is provided to each PE from the traceback control logic to activate the traceback logic within the PE, based on which each PE can then provide the path vector to the traceback control logic, which can be used for forming the final alignment for the sequence pair under consideration.

In an embodiment, traceback control logic can determine whether to continue the predicted traceback path based on the updates provided for current maximum value. If the new maximum value is triggered from the parent, which is part of the predicted traceback path, the sequence pair corresponding to current maximum can be added to the predicted path. If the new maximum value is derived from a new parent, the current predicted traceback path can be discarded and new path prediction can start based on the direction vectors of new set of parents. The sequence element pair of the new set of parents and the new maximum value PE can form the new predicted traceback path.

In an embodiment, for an M bp read and N bp reference sequence, the final alignment outputs along with scores and start and end position of alignments can be obtained in exactly M+N clock cycles from start of alignment. The alignment matrix can be completely filled for a sequence pair after M+N−1 clock cycles from start of alignment. The final traceback that proceeds in a recursive manner in parallel with the matrix fill stage can be obtained after (M+N) clock cycles from start of alignment. This final traceback can provide the optimal alignment for the query and subject sequence under consideration. The traceback path length is equal to the final optimal alignment length.

In yet another aspect, each of the kernels can provide a final optimal alignment output in the form of a sequence pair, wherein elements in the final alignment can be extracted from the traceback path vectors calculated by the traceback control logic. The kernel can also provide the maximum score, start positions and end positions of alignment as output.

In an embodiment, the hardware kernel can be of highly parameterized architecture. Most of the algorithmic and system parameters can be specified in the high level in the module hierarchy and passed to the lower modules, which allows different flavours of the accelerator and the cost function for the dynamic programming algorithm with minimal changes to the source files.

System for mapping and aligning a short read with a reference genome of the present disclosure can include a number of functional modules such as streaming module, mapping module and alignment module. The streaming module can be configured to stream the short reads and reference genome data through a system hardware. The mapping module can be configured to map the short reads with the reference genome based on one time indexing of the reference genome to generate a reference index table. In an embodiment the system can include multiple data paths in parallel such that each of parallel data paths include a mapping module followed by an alignment module. In an alternate embodiment, the hardware accelerator can function with independent, decoupled mapper and aligner models as well, where the mapper alone is present in the pipeline initially, which can perform mapping and filtering of read-RIT pairs, which are probable candidates for alignment. Thereafter, the filtered read-RIT pairs can be streamed to the accelerator again, which has only aligner present in the datapath, which can perform alignment on the incoming pairs, and produce the scores and associated results for each pair for streaming as output data.

The alignment module can be configured to align a mapped short read with the reference genome, wherein the alignment module incorporates a plurality of hardware kernels providing parallel datapaths wherein each of said hardware kernels can include an array of processing elements, and wherein each of the processing elements can hold one element of the reference genome, and elements of the short read can be shifted through the array of processing elements.

In an embodiment each of the processing elements of the alignment module can host a cost function of a dynamic programming algorithm for pairwise sequence alignment. In an aspect the cost function may not be limited to integer/floating point/fixed point etc and thus provide a choice of datatype. In an embodiment of application the dynamic programming algorithm can be Smith Waterman local pairwise alignment algorithm.

In another embodiment each of the hardware kernels of the alignment module can further include an alignment matrix fill block to populate a two dimensional alignment matrix with distance values during a forward scan. There can also be a traceback block to implement traceback in parallel with processing of alignment matrix fill block. The traceback uses traceback direction vectors from the array of processing elements.

Method for mapping and aligning a short read with a reference genome in accordance with the present disclosure can include steps of streaming the short read and the reference genome through system hardware. The reference genome can be preprocessed for one time indexing and generation of a reference index table. At next step the short read can be mapped against the reference genome based on the reference index table. Thereafter the mapped short read can be aligned with the reference genome. During the process the genomic data can be streamed through multiple data paths configured in parallel, each of these parallel data paths can include a mapper followed by an aligner.

Step of aligning a mapped short read with said reference genome can be implemented in plurality of hardware kernels configured to provide parallel datapaths, and each of these hardware kernels including an array of processing elements. During alignment each of the processing elements can hold one element of the reference genome and elements of the short read can be shifted through the array of processing elements. Further each of the processing elements in the array can host a cost function of a dynamic programming algorithm for pairwise sequence alignment.

Step of alignment can further include process to populate a two dimensional alignment matrix with distance values during a forward scan that can be implemented by an alignment matrix fill block. Further process of traceback in parallel with processing of alignment matrix filling is implemented by a traceback block that uses traceback direction vectors from the array of processing elements.

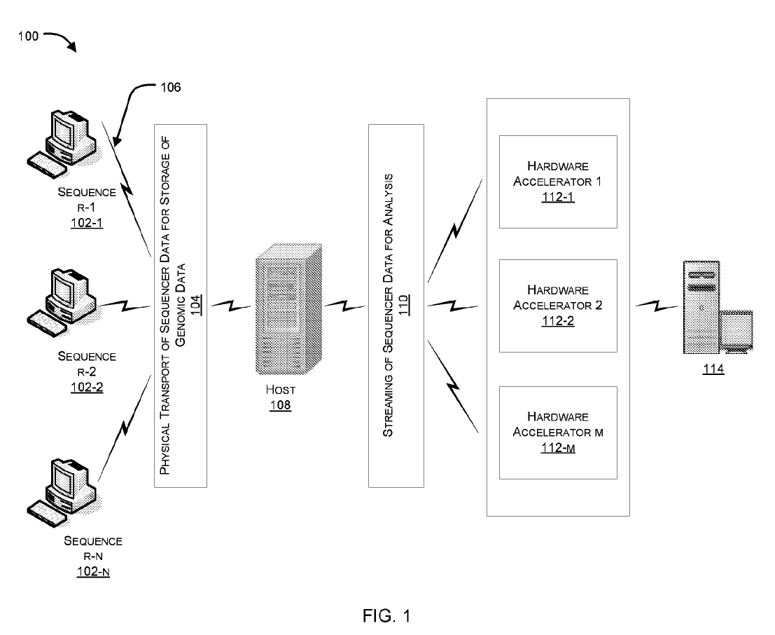

Various embodiments shall now be explained with reference to figures wherein FIG. 1 illustrates an exemplary block diagram 100 of general computational infrastructure for data transport from sequencing platforms for storage and analysis including the hardware accelerator for genomic data alignment in the data path in accordance with embodiments of the present disclosure. Sequencing research/clinical facilities 102-1, 102-2, . . . 102-N (collectively referred to as 102 hereinafter) typically produce terabytes of data, creating a huge demand for data storage coupled with server facility for secured access of data for analysis. These storage facilities such as 104 can be centralized or can be configured as local storages, which demands physical transfer 106 of raw data from sequencing platform to storages 104. Once stored, the data can be again physically transferred to a network, cloud, or custom made facility for genomic data alignment and visualization and preparation of final report for application.

In an embodiment, such a facility for genomic data alignment and visualization and preparation of final report for application can incorporate a host 108 and a number of hardware accelerators such as 112-1, 112-2, . . . 112-M (collectively referred to as 112 hereinafter). Hardware accelerators 112 can act as alignment clusters running in parallel with genomic data that is streamed 110 to them over any streaming protocol/methodology.

In an embodiment, the raw reads and reference genome can be downloaded and stored in in the host 108, wherein the reference genome can be indexed by the host 108 to generate RIT elements. These reads and RIT elements can then be paired, converted to binary, and then into hex to embed them as payload within a frame to be streamed to the hardware accelerators 112.

In an embodiment, genomic alignment cluster provides alignment data at accelerated speeds to a visualization and analysis engine 114 to derive the reports from alignment.

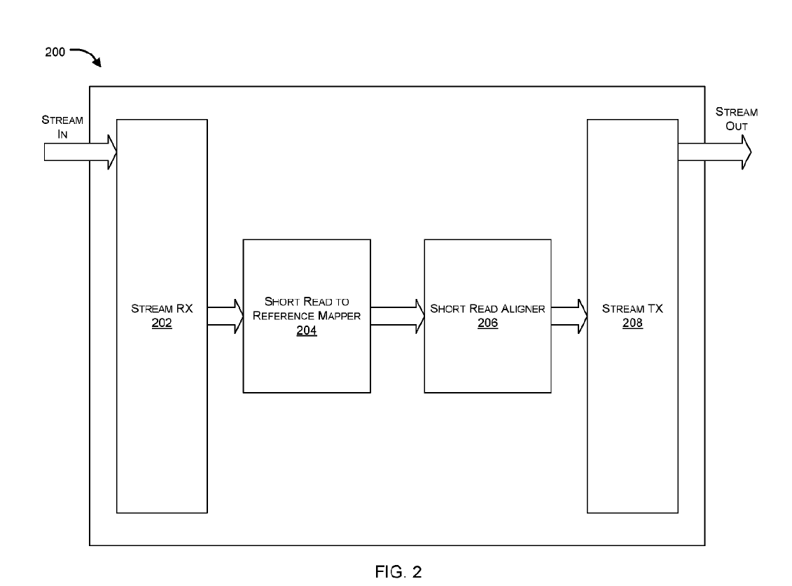

FIG. 2 illustrates an exemplary block diagram 200 of hardware accelerator architecture with the streaming interface in accordance with embodiments of the present disclosure. Hardware accelerator 112 can incorporate stream receive block 202 that can receive the stream duly embedded with genomic data from the host 108, and can preprocess them to extract short reads and RITs before transferring the extracted data to short read to reference mapper 204 (referred to as mapper 204 hereinafter).

In an embodiment, mapper 204 can map an incoming short read against the reference genome by looking for a hit in the RIT. A single short read can be paired against each of the elements within RIT to identify a map. The choice of masks, read length and seed length decides the complexity of the mapper 204. Mapping can be performed for different conditions such as absolute match of the short read and RIT element, single mismatch, two mismatches, three mismatches and so on. There can be a mask corresponding to each of these conditions.

In an aspect, hardware accelerator 112 can also incorporate a short read aligner 206 (also referred to as aligner) that can receive the short read and RIT element pair shortlisted by the mapper 204 and work on them to come up with an alignment score. The aligner 206 can have multiple parallel kernels. The hardware accelerator 112 can further incorporate a stream TX block 208 that can collect the results of alignment from parallel datapaths of aligner 206 and prepare them to stream back to the host 108. In an embodiment, there can be multiple data paths provisioned within the hardware accelerator 112 architecture.

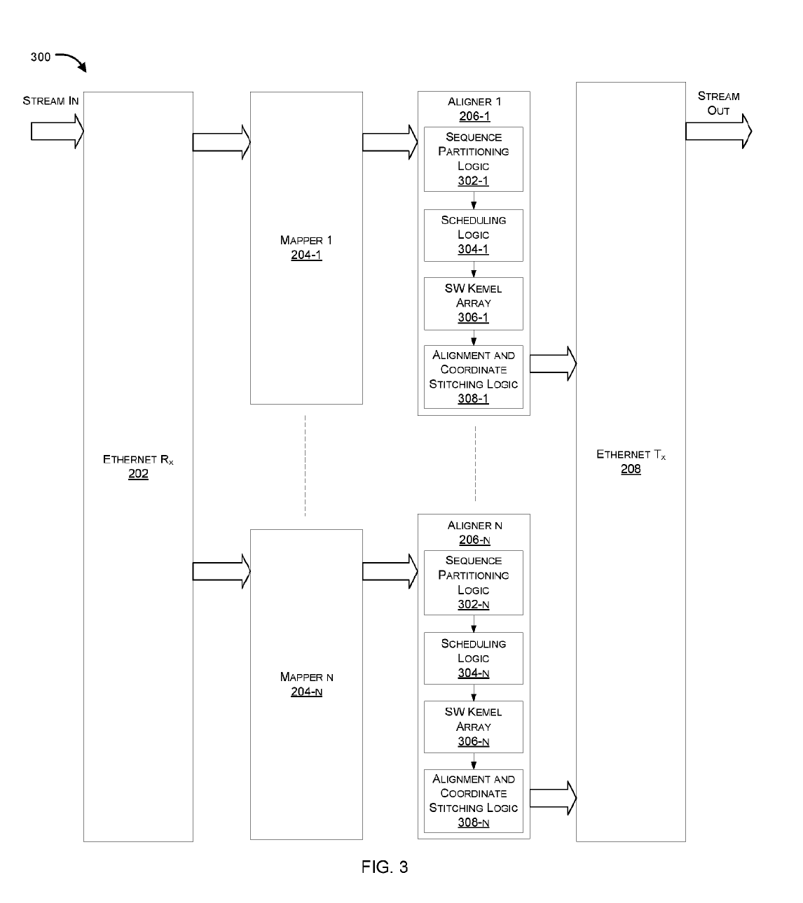

FIG. 3 illustrates an exemplary block diagram 300 indicating multiple datapaths for mapper and aligner within the hardware accelerator architecture in accordance with embodiments of the present disclosure. As illustrated, there can be multiple mappers such as 204-1, . . . 204-N in the hardware accelerator 112 each linked to a corresponding aligner 206 such as 206-1, . . . 206-N. Thus, the disclosed architecture of the proposed hardware accelerator 112 is scalable and can be scaled up to handle any genome mapping problem irrespective of its size.

In an embodiment, each aligner 206 can incorporate a partitioning logic block such as 302-1, . . . 302-N (collectively referred to as 302 hereinafter), a scheduling logic block such as 304-1, . . . 304-N (collectively referred to as 304 hereinafter), a kernel array 306-1, . . . 306-N (collectively referred to as 306 hereinafter), and an alignment and coordinate stitching logic block such as 308-1, . . . 308-N (collectively referred to as 308 hereinafter).

In an alternate embodiment, the hardware accelerator can function with independent, decoupled mapper and aligner models as well, where the mapper alone is present in the pipeline initially, which can perform mapping and filtering of read-RIT pairs, which are probable candidates for alignment. Thereafter, the filtered read-RIT pairs can be streamed to the accelerator again, which has only aligner present in the datapath, which can perform alignment on the incoming pairs, and produce the scores and associated results for each pair for streaming as output data.

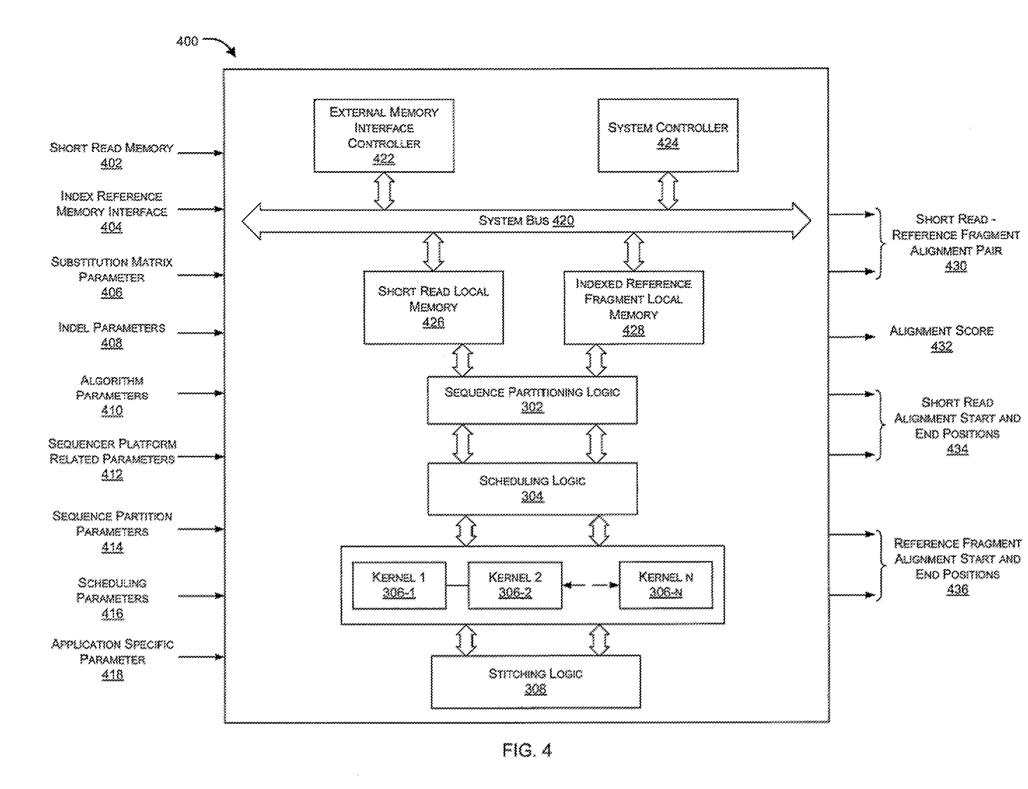

FIG. 4 illustrates an exemplary block diagram 400 indicating architecture of an aligner 206 in accordance with embodiments of the present disclosure. In an aspect, the disclosed aligner 206 can be parameterized and can perform alignment for various cost function models of the dynamic programming algorithm. The aligner 206 can have adequate sequence partitioning, scheduling, alignment and stitching schemes to accommodate short reads of variable lengths for alignment. The aligner 206 can receive various inputs such as short reads (through short read memory interface 402), indexed reference genome (through indexed reference memory interface 404), substitution matrix parameters 406, indel parameters 408, algorithm parameters 410, sequencing platform related parameters 412, sequence partition parameters 414, scheduling parameters 416 and application specific parameters 418, which inputs can be directed to relevant memory or logic blocks by external memory interface controller 422 through system bus 420.

In an embodiment, the aligner 206 can include a system controller 424, a short read local memory 426, and an indexed reference fragment local memory 428 to store relevant input data and make it available as and when required. Sequence partitioning logic block 302 and scheduling logic block 304 can stream the relevant genomic data to an array of kernels having the cost function model of the dynamic programming algorithm such as 306 having a number of kernels 306-1, 306-2, . . . 306-N.

In an embodiment, each of the kernels 306, which are the heart of aligner 206, can be modelled as processor array implementation of a cost function model of the dynamic programming algorithm having a number of processing elements (PE) with each processing element in the kernel holding one element (referred to as query element) of the reference genome (referred to as query sequence) and elements (referred to as subject elements) of the short read (referred to as subject sequence) shifted through the processor array. In an aspect, number of PE's can be scalable and tailored to meet input sequence size and the target platform requirements.

In an embodiment, output of the kernel array 306 can be received by an alignment and coordinate stitching logic block 308 that can provide output from aligner 206 in the form of short read-reference fragment alignment pair 430, alignment score 432, short read alignment start and end positions 434 and reference fragment alignment start and end positions 436.

In an embodiment, aligner 206 of the present disclosure can work for any application requiring accurate short read mapping and aligning like whole genome sequencing, resequencing, targeted resequencing, de novo sequencing, transcriptome sequencing, metagenomics, cancer genomics etc.

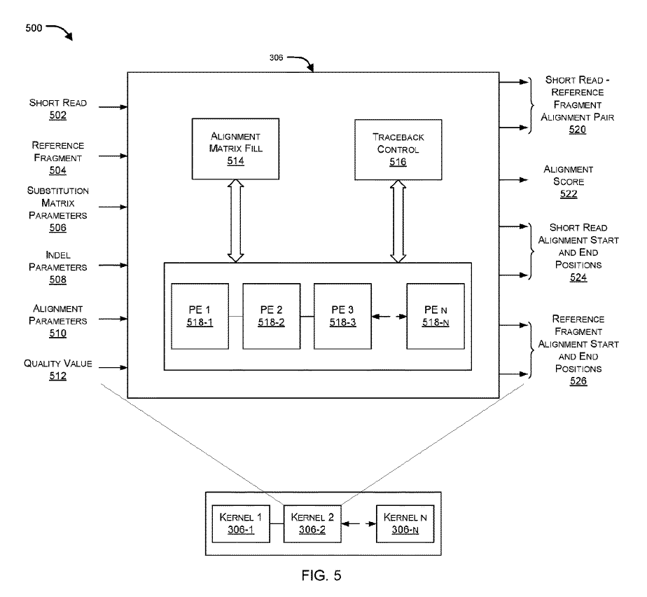

FIG. 5 illustrates an exemplary block diagram 500 indicating architecture of an alignment kernel 306 in accordance with present disclosure. The kernel 306 can receive genomic data and other inputs such as short read 502, reference fragment 504, substitution matrix parameters 506, indel parameters 508, algorithm parameters 510 and quality value 512 from scheduling logic block 304 of the aligner 206.

In an embodiment each of the kernels 306 can have an array of processors, which in its various embodiments can function as a parallel pipeline of hardware kernels. These processors (referred to as processing elements hereinafter) such as 518-1, . . . 518-N can be scheduled on any coarse grain reconfigurable architecture. Each of the processing elements 518-1, . . . 518-N in the array can host cost function of a dynamic programming algorithm for pairwise sequence alignment. The dynamic programming algorithm can be highly parameterized to encompass all variations of the algorithm for pairwise alignment. In an embodiment of implementation, the dynamic programming algorithm used can be Smith-Waterman dynamic programming algorithm and can implement affine gap penalty model and substitution matrix for computing costs for local pairwise sequence.

Thus each of the kernels 306 can be modelled as processor array implementation of the cost function model of the dynamic programming algorithm including a number of processing elements such as 518-1, . . . 518-N, each processing element in the kernel can hold one element (referred to as query element) of the reference genome (referred to as query sequence) and elements (referred to as subject elements) of the short read (referred to as subject sequence) can be shifted through the processor array. In an aspect number of PE is scalable and can be tailored to meet the input sequence size and the target platform requirements.

In an embodiment, the hardware kernel can incorporate an alignment matrix fill block 514 that can populate a two dimensional alignment matrix with score or distance values during forward scan from top left cell to bottom right cell and can do score calculation. In another embodiment, the hardware kernel can further incorporate a traceback control block 516 configured to implement traceback. In another embodiment, incorporation of the traceback control block 516 as a separate hardware can enable traceback in parallel to the processor array and alignment matrix filling process by use of trace back direction vectors from PEs 518 and using additional trackback path prediction features.

In an embodiment, each of the PEs 518 can implement the cost function model of the dynamic programming algorithm for local pairwise sequence alignment. The substitution matrix look up table within the processing element can be implemented for the chosen standard substitution matrix like DNAfull. In an embodiment, to accommodate a new substitution matrix, the look up table just needs to be changed for the values.

In another embodiment, the penalty attributed to a gap, and extension of a gap, can also be stored in the PEs 518. The PEs 518 can keep track of the maximum value generated in the matrix so far. The maximum value can thus be propagated from start to end of the processor array. The last PE in the array can provide maximum value as the highest score output from the kernel.

In another embodiment, the PEs 518 can also save the direction of cell update based on location of parent cell from which current update value was calculated. A cell update can happen from the cell on top or the cell to its left or from the top left diagonal cell. This can be shared with the traceback control logic in the kernel in the form of traceback direction vector. This can serve as an input to direction calculation and path prediction during traceback process.

In another embodiment, for every clock, the PEs 518 can check whether current pairing due to alignment is match or mismatch. If a match is found, the PEs 518 can calculate the score based on the score or substitution matrix. If a mismatch is found, the PEs 518 can calculate the penalty for a gap based on affine gap model and gap and gap extension penalty values.

In an embodiment, whenever a match is found in the input element pair, the corresponding diagonal match value and diagonal indel value can be calculated in parallel. The values can be compared to find the maximum between the two. The resultant maximum value can then be added to the match score value obtained based on the substitution matrix look up table. This value can then be processed to provide final match value to be communicated to the next PE 518.

In another embodiment, whenever a mismatch occurs in the input sequence element pair, the indel value can be calculated based on the gap open penalty and gap extension penalty values. The maximum of the gap open penalty from the left and gap extension penalty from the left is calculated. This can be compared against the maximum of gap open penalty and gap extension penalty from the top cell. The maximum of left penalty and top penalty can be found to finally obtain the indel value to be transferred to the next PE 518.

In an embodiment, the processing element can complete its job by traversing through four internal stages of the control state machine, namely init, alignment, scoring, and traceback. The PEs 518 can be initialized for its look up table, gap open penalty, gap extension penalty values, and for other system parameters during the init state. PE 518 can then wait for the valid command indicating the start of alignment. The PEs 518 can be triggered for an alignment by an active high on the valid signal, following which the PE 518 can receive input sequence elements.

In an embodiment, the PEs 518 can now proceed to the scoring state where the alignment matrix can be filled based on the cost function model of the dynamic programming algorithm. The traceback can happen in parallel with alignment in this stage. This state machine can be active in all the PEs within the kernel in parallel during the alignment matrix fill process and traceback. At the end of matrix fill contributed by all the PEs 518, the optimal alignment and the maximum score can be provided as output of the kernel. The PEs 518 can now get back to the init state waiting for the next set of inputs.

In an embodiment, each PE 518 can perform one elementary calculation per clock based on the cost function model of the dynamic programming algorithm. Each PE 518 can be responsible for populating one column of the alignment matrix. Each of the PEs 518 can generate one alignment matrix element per clock. The calculation of current PE 518 can depend on the results of the previous PE 518 or parent. Thus each PE 518 can be one cycle behind the predecessor in the processor chain. Each kernel can thus generate one complete alignment matrix for one sequence pair alignment.

In an embodiment, the maximum value calculated during each cell update can be propagated across the processor array. PEs 518 in the array can calculate the current cell update value, and compare it with the input maximum value. If the current value is greater than the maximum value hit so far, the maximum value can be replaced by the current update value and propagated to the next PE 518. The last PE 518 in the processor array can thus provide the highest score in the alignment matrix as output.

In an embodiment, while the alignment matrix is being populated, a traceback can be triggered for the current maximum value after evaluating whether it is eligible for a traceback. The eligibility for traceback can be calculated based on the direction vectors populated by each PE for each matrix cell update. The direction vectors can be calculated based on the parameters such as current score value, the parent cell from which the current value was calculated, the relative position of the current PE 518 from the parent PE 518, current maximum value, the parent cell from which reported the current maximum value, the relative position of the current PE from the maximum value PE 518.

In an embodiment, if there is a valid path defined by the direction vectors of the parents preceding the current maximum value PE 518, a traceback can be triggered. The traceback enable signal and the traceback ID provided to each PE from the traceback control logic can activate the traceback logic within the PE 518. Each PE 518 can then provide the path vector to the traceback control logic which can be used for forming the final alignment for the sequence pair under consideration.

In an embodiment, traceback control logic can determine whether to continue the predicted traceback path based on the updates provided for current maximum value. If the new maximum value is triggered from the parent, which is part of the predicted traceback path, the sequence pair corresponding to current maximum can be added to the predicted path. If the new maximum value is derived from a new parent, the current predicted traceback path can be discarded and new path prediction can start based on the direction vectors of new set of parents. The sequence element pair of the new set of parents and the new maximum value PE can form the new predicted traceback path.

In an embodiment, for an M bp read and N bp reference sequence, the final alignment outputs along with scores and start and end position of alignments can be obtained in exactly M+N clock cycles from start of alignment. The alignment matrix can be completely filled for a sequence pair after M+N−1 clock cycles from start of alignment. The final traceback that proceeds in a recursive manner in parallel with the matrix fill stage can be obtained after (M+N) clock cycles from start of alignment. This final traceback can provide the optimal alignment for the query and subject sequence under consideration. The traceback path length is equal to the final optimal alignment length.

In yet another aspect, each of the kernels 306 can provide a final optimal alignment output in the form of a short read-reference fragment alignment pair 520. The elements in the final alignment are extracted from the traceback path vectors calculated by the traceback control logic. The kernel can also provide the alignment score 522, short read alignment start and end positions 524 and reference fragment alignment start and end positions 526 as output.

In an embodiment, the hardware kernel 306 can be of highly parameterized architecture. Most of the algorithmic and system parameters can be specified in the high level in the module hierarchy and passed to the lower modules. This allows different flavours of the accelerator and cost function for the dynamic programming algorithm with minimal changes to the source files.

In an example implementation to analyze the performance of the proposed alignment system, a kernel with a processor array of 8 PEs was instantiated, which was used to perform Smith-Waterman affine gap penalty model based local alignment of two sequences each with 8 residues in it (M=8 is the length of the query sequence, and N=8 is the length of the subject sequence). The resultant alignment matrix was of size 8×8 (M×N), wherein each PE generated one column alignment matrix after N cycles (8 cycles). The full alignment of two sequences was achieved in 15 cycles (M+N−1 cycle) from the start of alignment. The traceback was performed in parallel with the alignment matrix population, and the final alignment was available at the output as a pair of aligned sequences after 16 clock cycles (M+N cycles), from the start of alignment.

Performing traceback parallel to matrix fill can save number of clock cycles spent on traceback as compared to systems in which traceback is triggered post matrix fill. This yields a faster output from the kernel 306. This further enhances the throughput from the architecture, enabling more sequences to be aligned over a given time. The kernel 306 was also tested with input sequences with lengths lesser than eight. The kernel was found to provide final optimal alignment after M+N cycles from start of alignment for those sequences.

Table 1 below illustrates the results of alignment matrix fill process using the disclosed kernel:

Table 1 above illustrates how forward scan process proceeds from top left cell to bottom right cell. The table also shows parallel operation of 8 PEs along anti-diagonal wave front through alignment matrix. Kernel thus requires 15 clock cycles for a matrix fill as the wave front propagates through the matrix.

In the example implementation, performance of a short read aligner 206 configured with disclosed kernel array 306 and for alignment of 32 bp short reads in accordance with embodiments of the present disclosure was analysed. It was assumed that the reference indexing for this alignment has been done with setting of seed length same as the read length. The resultant reference sequence fragments corresponding to each of the short read can be of same length as the short read. Alignments were performed for absolute match and single mismatch. Four basic kernels were used for alignment, one for each of the four pairs of read reference fragment partitions. Each kernel can thus perform alignment and generate score, final alignment, and start and end positions of alignment in exactly 16 clock cycles. The final alignment can thus be produced by four kernels running in parallel, each providing the partial outputs in 16 clock cycles. Appropriate scheduling of alignment was done so that the final output of 32×32 alignment is obtained in 16 clock cycles. Results of alignment from hardware were verified against the EMBOSS aligner software. To analyse the performance gain of the short read aligner three possible scenarios were considered for performing local alignment of input sequences, each having 32 residues in it.

Scenario 1: Alignment performed using the sequence alignment engine

Scenario 2: Alignment performed using the proposed kernel model with 32 PEs

Scenario 3: Alignment performed using a conventional FPGA based hardware accelerator using processor array, where the accelerator performs only score calculation, and traceback and alignment are done in software.

Table 2 below gives a comparison of the performance parameters and architecture features of the above three scenarios.

TABLE 2
Performance comparison of short read aligner
Short Read Aligner Feature Comparison

| | Scenario 1 | Scenario 2 | Scenario 3 |
|---|---|---|---|
| | M = 32, | M = 32, | M = 32, |
| Features | N = 32 | N = 32 | N = 32 |
| Read Length | 32 | 32 | 32 |
| Reference | 32 | 32 | 32 |
| Fragment Length | | | |
| Scoring in | YES | YES | YES |
| Hardware | | | |
| Traceback in | YES | YES | NO |
| Hardware | | | |
| Input Sequence | YES | NO | NO |
| Partitioning | | | |
| Stitching of Optimal | YES | NO | NO |
| Tracebacks | | | |
| Final Score as | YES | YES | YES |
| Output | | | |
| Final Score as | YES | YES | YES |
| Output | | | |
| Final Alignment as | YES | YES | NO |
| Output | | | |
| Memory | NO | NO | YES |
| Bottleneck Issues | | | |
| Recomputing | NO | NO | YES |
| Alignment Matrix | | | |
| for Qualified pairs | | | |
| No of clock cycles | 16 | 63 | 63 |
| for Alignment | | | |
| Matrix Fill | | | |
| No of clock cycles | 16 | 64 | Final alignment |
| for final alignment | | | done in |
| | | | software |

As can be seen, parallel Smith-Waterman kernel implementation with adequate sequence partitioning and scheduling techniques and with traceback overlapping the alignment procedure in scenario 1 can perform alignment in 16 clock cycles. A kernel model with 32 PEs in scenario 2 with traceback overlapping the alignment procedure performs the alignment in 32 clock cycles. However, in scenario 3 where a conventional processor array based hardware accelerator for Smith-Waterman as in existing reconfigurable hardware solutions that performs only scoring function, it took 63 clock cycles for arriving at the maximum score. The host processor later uses this score to arrive at the final alignment, which is very much compute intensive and time consuming. This method, as the size of matrix grows, has limitations such as computational complexity and memory bottleneck issues.

It is evident from the above comparison that the disclosed short read aligner takes least time to perform the complete alignment, provide score and start and end positions of the alignment as compared to existing methods. Thus, computation of traceback in hardware provides a significant performance improvement when compared with traditional hardware accelerator based high performance systems in spite of the traceback computation being a linear time complexity problem. A combination of optimal parameters and traceback enabled hardware kernel can tremendously increase overall performance and throughput of the system for real life biological sequencing.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### Advantages of the Invention

The present disclosure overcomes the drawbacks of existing methods of short read mapping and alignment with a reference genome sequence.

The present disclosure provides a hardware accelerator that overcomes the drawbacks of existing methods of short read mapping and alignment with a reference genome sequence.

The present disclosure uses a cost function model of the dynamic programming algorithm for pairwise sequence alignment of a short read with a reference genome sequence to achieve accurate results.

The present disclosure provides an accelerator architecture that supports streaming of genomic data from host, thereby drastically reducing storage requirements within the accelerator platform while indexing, mapping and alignment and speeds up the mapping and alignment of short reads with a reference genome.

The present disclosure provides an aligner architecture that enables traceback parallel to alignment matrix filling process thus saving alignment time.

We claim:

1. A system for mapping and aligning a short read with a reference genome comprising:
a streaming module configured to stream said short read and said reference genome through a system hardware;
a mapping module configured to map said short read with said reference genome; and
an alignment module to align a mapped short read with said reference genome, wherein said alignment module incorporates a plurality of hardware kernels providing parallel datapaths, and wherein each of said hardware kernels comprises an array of processing elements, and wherein each of said processing elements holds one element of said reference genome, and wherein elements of said short read are shifted through said array of processing elements.

2. The system of claim 1, wherein each of said processing elements in the said array of processing elements hosts a cost function of a dynamic programming algorithm for pairwise sequence alignment.

3. The system of claim 2, wherein said dynamic programming algorithm is Smith Waterman local pairwise alignment algorithm.

4. The system of claim 1, wherein each of said hardware kernels further comprises an alignment matrix fill block to populate a two dimensional alignment matrix with distance values during a forward scan.

5. The system of claim 4, wherein each of said hardware kernels further comprises a traceback block to implement traceback in parallel with processing of alignment matrix fill block, wherein said traceback uses traceback direction vectors from said array of processing elements.

6. A method for mapping and aligning a short read with a reference genome comprising:
streaming said short read and said reference genome through a system hardware;
mapping said short read with said reference genome; and
aligning a mapped short read with said reference genome, wherein a plurality of hardware kernels are configured to provide parallel datapaths, and wherein each of said hardware kernels comprises an array of processing elements, and wherein each of said processing elements holds one element of said reference genome, and wherein elements of said short read are shifted through said array of processing elements.

7. The method of claim 6, wherein each of said processing elements in the said array of processing elements hosts a cost function of a dynamic programming algorithm for pairwise sequence alignment.

8. The method of claim 6, wherein said dynamic programming algorithm is Smith Waterman local pairwise alignment algorithm.

9. The method of claim 6, wherein each of said hardware kernels further comprises an alignment matrix fill block to populate a two dimensional alignment matrix with distance values during a forward scan.

10. The method of claim 6, wherein each of said hardware kernels further comprises a traceback block to implement traceback in parallel with processing of alignment matrix fill block, wherein said traceback uses traceback direction vectors from said array of processing elements.
